(19) United States
(12) Patent Application Publication
(10) Pub. No.: US 2011/0029168 A1
(43) Pub. Date: Feb. 3, 2011

(54) Route oriented paradigm for hybrid vehicles using route calculation and system utilizing same

(76) Inventor: Howard Barry Talberg, Santa Cruz, CA (US)

Correspondence Address: Michael A. Guth, 2-2905 East Cliff Drive, Santa Cruz, CA, 95062, US

(21) Appl. No.: 11/825,653

(22) Filed: Jul. 6, 2007

(51) Int. Cl. B60W 20/00; G01C 21/00; B60W 10/06; B60W 10/08

(52) U.S. Cl. 701/22; 701/200; 903/903

(57) ABSTRACT

A method and apparatus for controlling the operation of a hybrid drive system utilizing route information. The route information may be learned by the vehicle's control system using an exemplary drive of the route or entered into the vehicle's control system manually or in conjunction with mapping or other software. A method for optimizing cost efficiency using a route oriented paradigm for operation of a hybrid drive system.

### BACKGROUND

1. Field of the Invention

This invention pertains generally to hybrid powered vehicles employing both electric motors and auxiliary power units, and more particularly to controlling the relative operation of the electric motor and an auxiliary power unit such as an internal combustion engine in a parallel or series hybrid powered vehicle based at least in part on information pertaining to the route to be driven.

2. Description of Related Art

A hybrid electric vehicle (HEV) is a vehicle with electricity as the primary energy source and an auxiliary power unit (APU) as the secondary source. The APU is typically an internal combustion engine (ICE) utilizing reformulated gasoline, methanol, ethanol, or compressed natural gas as a fuel source. Hydrogen fuel cells may also become common in the future. The electrical energy is stored in chemical storage batteries or capacitors. A series hybrid electric vehicle uses the ICE to drive a generator which supplies power to the electric motor (EM) or charges the batteries, whereas a parallel hybrid uses the ICE to directly drive the wheels. In both configurations, the ICE is used to supplement the energy capacity and power capability of the battery pack.

A series hybrid is the most common powertrain configuration choice among HEV designers due to its low emissions capability, fuel economy, and simple EM/ICE integration. A series hybrid has the capability to use the ICE to charge the batteries while driving. Ideally, the ICE is point-tuned to operate under constant load and speed at the point of lowest specific fuel consumption, which could produce low tailpipe emissions. The EM and ICE are only electrically connected, allowing each power source to be independently placed in the vehicle, further adding to the simplicity of a series hybrid. Series hybrids, however, suffer from inherent energy losses due to the many energy conversions required to convert chemical fuel energy to motive energy at the wheels. Thus, what is gained from engine efficiency is lost to electrical and/or electrochemical inefficiency.

A parallel hybrid on the other hand, using a properly-sized ICE to directly transmit torque to the drive wheels, can provide better overall efficiency than a series hybrid. The engine can be sized so that, at wide-open throttle, the ICE maintains steady-state highway speeds and operates at its peak efficiency. In addition, the ICE can be tuned for excellent fuel economy and low tailpipe emissions. Most parallel hybrid vehicles are configured with a large ICE, however, leading to poor fuel economy and high cost. The EM is selected for urban driving and acceleration, since the ICE may not provide the power required for this driving demand. In emergency situations, the ICE can provide “limp-home” capability when the batteries reach a depth of discharge (DOD) where the EM can no longer accelerate the vehicle.

Various control strategies have been previously developed for operating the EM and ICE in hybrid vehicles. For example, U.S. Pat. No. 5,343,970 discloses a hybrid vehicle where, at low speeds or in traffic, the EM alone is used to drive the vehicle. Under acceleration and during hill climbing, both the EM and ICE are used. At steady state highway cruising, only the ICE is used. The control system also senses battery charge and uses the ICE to charge the battery when necessary. U.S. Pat. No. 4,923,025 discloses a hybrid vehicle which operates on an EM until a predetermined cruising speed is reached. The ICE is then brought on line and the EM is turned off. U.S. Pat. No. 4,042,056 discloses a hybrid vehicle which is powered by an EM except in circumstances where the battery charge is depleted, in which case an ICE is brought on line.

A drawback of the aforementioned schemes is that they do not take into account in advance information relating to the route to be driven. For example, many drivers drive a pre-determined route as part of a commute to and from work, and may take advantage of free electrical recharging while at work. Also, many drivers may drive to a location in a city where recharging is also offered, often at no charge. Route information may be available regarding distance, type of driving (stop and go, medium speed, hiway), and elevations gained and lost. The increased use of electric power utilizing such paradigms may be vastly more efficient overall, as well as an environmentally sounder approach.

What is called for is a driving paradigm that takes route information into account, and allows the driver to maximize dependence on electrical power, which may be replenished in some cases by recharging due to downhill driving or in other cases by recharging at a known destination, or on a different method of optimization. What is also called for is a system that allows route information to be either “remembered” during an exemplary drive or programmed in.

### SUMMARY

A method and apparatus for controlling the operation of a hybrid drive system utilizing route information. The route information may be learned by the vehicle's control system using an exemplary drive of the route or entered into the vehicle's control system manually or in conjunction with mapping or other software. A method for optimizing cost efficiency using a route oriented paradigm for operation of a hybrid drive system.

### BRIEF DESCRIPTION OF THE DRAWINGS

FIG. 1 illustrates a hybrid drive system according to some embodiments of the present invention.

FIG. 2 illustrates a route to be driven using a hybrid drive system according to some embodiments of the present invention.

FIG. 3 illustrates a vehicle with an input terminal according to some embodiments of the present invention.

FIG. 4 is a flow chart illustrating the use of a hybrid drive system according to some embodiments of the present invention.

### DETAILED DESCRIPTION

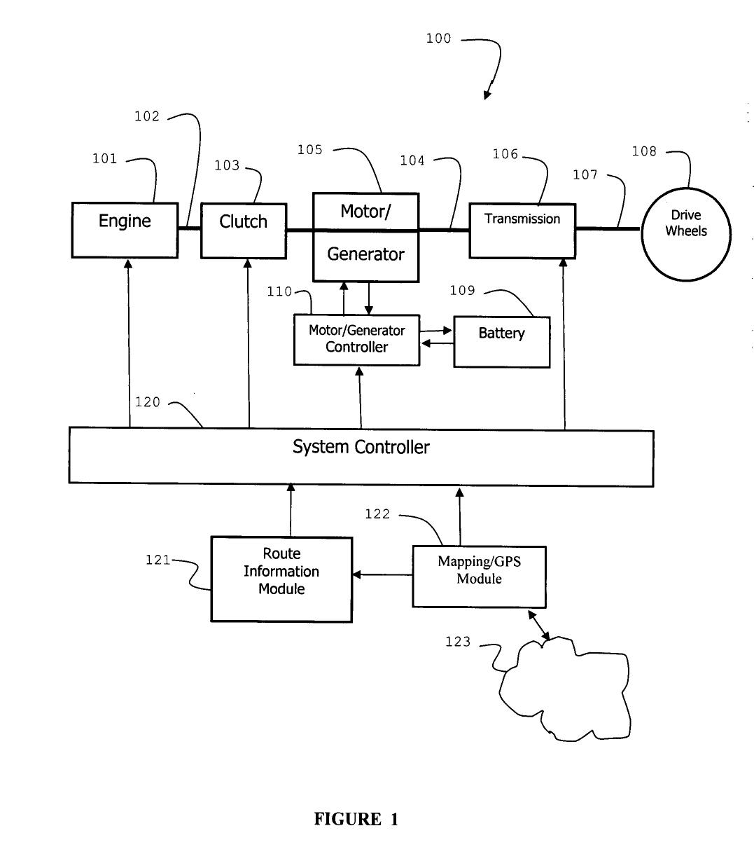

In some embodiments of the present invention, as seen in FIG. 1, a hybrid drive system 100 is adapted to utilize route information in order to modify the control of the hybrid system. An electric motor 105 is coupled to the input shaft 104 of a transmission 106, which may be a continuously variable transmission, so that it injects power in conjunction with the drive train 102 between the engine 101 and the transmission 106. The drive train 102 may have a clutch 103. The electric motor 105 is powered by a battery 109, which may be a bank of batteries. The operation of the electric motor is controlled by a motor controller 110, which is in turn controlled by a system controller 120. The system controller may be a micro-processor or computer based programmable system controller.

The size of the electric motor 105 may vary, and may the electric motor 105 may also function as a generator that can be used to charge the batter 109. In that regard, the motor controller may also be a motor/generator controller. The transmission may be of a variety of types as well. The hybrid drive system may also be of a different nature in some embodiments of the invention, whether a parallel or series system, or other system utilizing an engine and an electric motor.

In some prior art systems, the control of use of the engine in conjunction with the motor involves factors such as the torque requested to be delivered by the driver (via the accelerator pedal), the speed of the vehicle, and other factors. In many modern driving scenarios, the driver repeats the same driving route many times. An example would be the driver who used the vehicle to commute to work on a daily basis. The driver would typically take the same route every day, or a route very close in nature to that route. The route information may include information relating to the length of the route, the type of driving on the route (hiway, stop and go, etc.), the altitude gains and losses on the route, and other information. The use of known route information may be used to modify the control of the hybrid drive system, and in particular the relative amount of user of the engine and the electric motor.

Of interest in the modern work environment, as well as with many urban areas, is that there are many recharge stations available for recharging of the batteries of a hybrid vehicle. In an effort to promote the use of electric vehicles, and discourage the use of combustion engines, many work places and many urban centers offer the use of the recharge stations at no cost to the user. Thus, a user seeking to minimize the personal cost of using the vehicle may choose to rely more heavily on electric power than other users if free recharge stations are available to them. The location of the next recharge station at which the vehicle will be docked then may become a factor in the control of the hybrid system.

In some embodiments of the present invention, as seen in FIG. 1, a route information module 121 provides information to the system controller. In some embodiments, the route information module 121 may be contained within the system controller. The route information module 121 may receive inputs from the driver using a touch screen within the vehicle or using other methods. The driver may input information relating to the length of the route, the type of driving on the route (freeway, stop and go, etc.), the altitude gains and losses on the route, and other information. The route information module may include functionalities for recording information of a particular route as the route is driven. The driver may also enter information about the current day's traffic level in some embodiments. This information may be manually entered, or may be entered into the route information module via a wireless module that is connected to a traffic information provider. The driver may also enter information regarding the level of “lead-footedness” of the driver, allowing this potential increased use of power to be used in calculating the power mode. In addition, the “lead-footedness” may be recorded during a route when driven by a certain driver, allowing that driver's driving style to be characterized. The route information module may record and save a plurality of different drivers' driving styles, and allow the driver to identify themself to allow for proper calculation.

A mapping module 122 provides information to the route information module 121 in some embodiments. In some embodiments, the mapping functionalities may be contained within the route information module itself. The mapping module may include functionalities for calculating the expected distance, driving type, and altitude changes for a particular pre-selected route. The mapping module may contain information within in it in memory or may be connected to a computer network 123, such as the interne, via wireless connection or other means. Within the mapping module there may be GPS functionalities, and there may also be an altimeter to allow altitude change information to be recorded when the route information module is recording information about a particular route.

The route information provided by the route information module may be used in conjunction with other information, for example, the depth of discharge of the batteries. A running mode for the vehicle based on route information may be affected by the starting depth of discharge, for example, and whereas with full batteries there may have been enough charge to solely utilize electric power based on the route information, the running mode may be calculated differently when the route is begun on half discharged batteries.

Although the route information module has been described above in support of a system controller for a hybrid vehicle, the route information module may also be used to support other types of vehicles in other modes. For example, the route information module may be used in conjunction with an auto-pilot system.

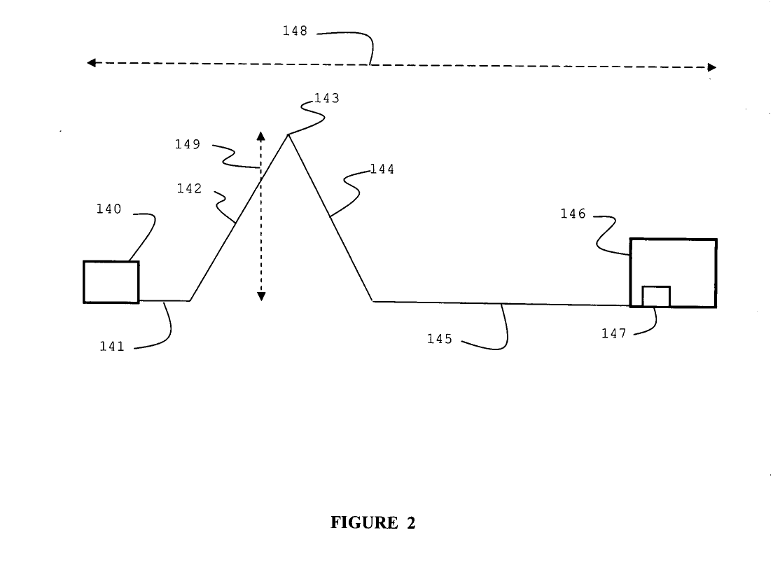

FIG. 2 illustrates an example of a first route 148 that may be driven by a commuter. The commuter begins at home 140 and travels to work 146. The workplace may have a recharging station 147. Many workplaces have begun to provide free recharging of employee vehicles, whether as a result of regulation, available tax breaks, or for other reasons. The overall route 148 may have a variety of types of segments. The driver may drive a short segment 141, and may then drive an uphill segment 142 gaining altitude 149. Once at the peak of the hill 143, the route may descend for a segment 144, and then may have a long flat segment 145 to the workplace.

Prior regimes of controlling the relative work output of the engine and the electric motor have been unable to maximize reliance on the batteries, and the electric motor, in such circumstances. For example, the hybrid vehicle may have enough battery power stored to make it up to the peak of the hill 143, and then may utilize the downhill segment to partially (or fully) recharge the batteries, either utilizing braking systems that rely on the back force from the generator function of the electric motor, or by a separate generator that is able to be geared up during downhill driving, or through other means. Thus, when the vehicle enters the last flat segment 145, there may sufficient charge remaining in the batteries to drive to the workplace 146 without ever having used the combustion engine. The system controller 120 may take the information from the route information module 121 and determine that the vehicle may use solely electric power and still meet the driving requirements of the route. Also, with the information that there will be a charging station at the end of the route, the system may then run solely on electric power.

The opportunity to maximize harvesting of energy during deceleration on downhill segments in this fashion allows for a minimization of use of the internal combustion engine. Thus, as part of the route information, the downhill segments are used in calculations of battery only operational range as a source of recharge.

The vehicle route information for this first route may have been manually entered into the route information module using a touch screen or other device, or may have been entered with the use of a mapping module based on start on stop points and other information, or may have been recorded on an earlier trip using the same route.

The return trip may have a different makeup, even though it is just the reverse route of the first trip. For example, the length of the flat segment 145 driven after leaving the workplace, combined with the altitude gain of the second segment 144, may deplete the batteries prior to reaching the summit 143 if only the batteries are used. This is in contrast to the first route, where the initial segment 141 was much shorter. In this case, the data supplied by the route information module may be used to calculate how much power to derive from the engine, and where to use it most efficiently, to achieve the summit. After achieving the summit, the vehicle batteries may once again be able to recharge using the gravity of the descending segment 142. Once home, the vehicle may recharge fully.

Of note in the foregoing example is how different routes may utilize the engine and electric motor in different ways depending upon the distance of the route, the type of route, the altitude changes in the route, the distance to the next charging station, and other factors. Also of note is that a route driven in one direction may be driven in a different mode than the same route driven in the return direction.

In some embodiments, either the route information module, or the mapping module, or both, include a positioning capability such as GPS which allows for determination of the vehicle location. Thus, the vehicle could ascertain, for example, at which point in the route it is, and at which point it may alter the engine/motor work schedule. Also, the position information may allow the route information module and the system controller to update the calculations regarding engine use during a route.

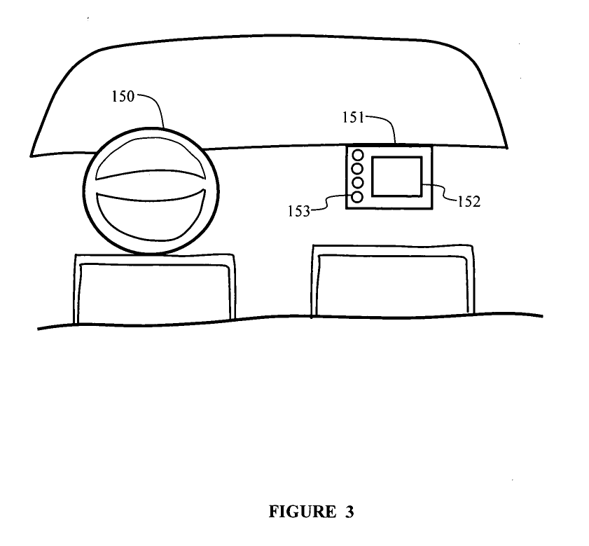

FIG. 3 illustrates an interior of a vehicle using a hybrid drive system according to some embodiments of the present invention. A route information module 151 may include control button 153 and a viewing screen 152. In some embodiments, the viewing screen may be a touch screen adapted to receive inputs. The route information module 151 may include memory for storing of previously entered routes. The route information module 151 may allow for the entry of route information on a segment by segment basis, including distance, altitude gain/loss, type of driving expected, and other information. The route information module 151 may allow for a route about to be driven to be recorded with regard to route information. The route information module 151 may work in conjunction with a mapping module which may allow for automatic entry of route information based upon the selection of start and stop points.

In some embodiments, the battery depletion would not be scheduled to lower beyond a certain reserve level to allow for contingencies, such as the need for extra electric power in case of emergency or other need. The route information module may allow the user to program which level of reserve to calculate around when the power calculations are performed.

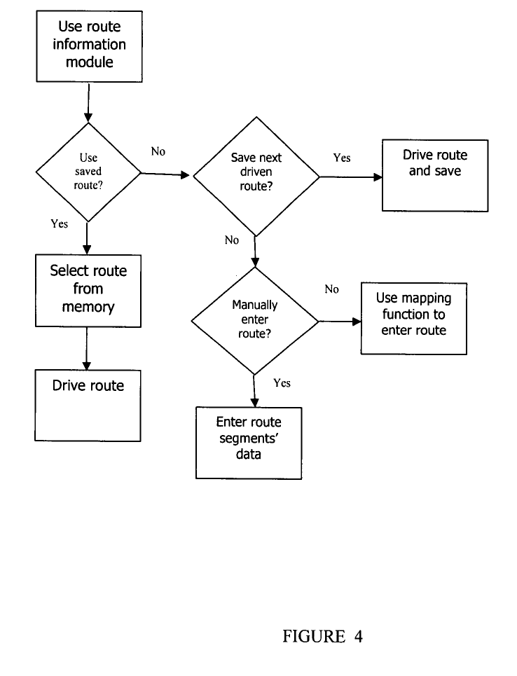

FIG. 4 illustrates a flow chart illustrating the use of a route oriented paradigm according to some embodiments of the present invention.

As evident from the above description, a wide variety of embodiments may be configured from the description given herein and additional advantages and modifications will readily occur to those skilled in the art. The invention in its broader aspects is, therefore, not limited to the specific details, representative apparatus and illustrative examples shown and described. Accordingly, departures from such details may be made without departing from the spirit or scope of the applicant's general inventive concept.

I claim:

1. A method of controlling the operation of a hybrid electric vehicle having an electric motor, a battery powering the electric motor, and an auxiliary power unit, comprising the steps of:
(a) entering vehicle route information into a control system; and
(b) minimizing the use of the auxiliary power unit and using the electric motor to power the vehicle based at least in part on the vehicle route information.

2. The method of claim 1 further comprising the step of determining whether the vehicle route is within travel range of the vehicle using solely the electric motor.

3. The method of claim 2 further comprising the step of utilizing solely the electric motor on a route determined to be within travel range of the vehicle using solely the electric motor.

4. The method of claim 1 wherein the step of entering vehicle route information into a control system comprises manually entering said vehicle route information.

5. The method of claim 1 wherein the step of entering vehicle route information into a control system comprises entering a starting point of the vehicle route and the end point of the vehicle route.

6. The method of claim 5 further comprising the step of determining more detailed route information from an electronic memory storage based on said starting point and said end point of the vehicle route.

7. The method of claim 1 wherein the step of entering vehicle route information into a control system comprises recording the vehicle route while driving the vehicle along the route in a first instance.

8. The method of claim 2 wherein the step of determining whether the vehicle route is within travel range of the vehicle using solely the electric motor includes utilizing the initial depth of discharge of the vehicle batteries in the determination.

9. The method of claim 8 wherein the step of determining whether the vehicle route is within travel range of the vehicle using solely the electric motor includes calculating battery recharge during vehicle descent during the traveling of the route.

10. A hybrid drive vehicle system comprising:
an engine;
an electric motor;
a system controller, said system controller adapted to allow for the operation of said engine in conjunction with said electric motor in some circumstances; and
a route information module, said route information module adapted to provide route information to said system controller.

11. The hybrid drive vehicle system of claim 10 wherein said route information module comprises an interface for the input of route information by a user.

12. The hybrid drive vehicle system of claim 11 further comprising a mapping module, said mapping module adapted to provide route information based upon the input of a starting point and an end point of a route.

13. The hybrid drive system of claim 10 wherein said route information module comprises memory storage for the storage of previously entered route information.

14. The hybrid drive system of claim 11 wherein said interface is a touch screen interface.

15. The hybrid drive system of claim 10 wherein said route information includes distance information.

16. The hybrid drive system of claim 10 wherein said route information includes altitude information.

17. The hybrid drive system of clam 10 wherein said system controller determines the amount of engine use during a drive based at least in part on said route information.

18. A route information module adapted to store the information pertaining to a driving route, said module comprising:
a memory storage device;
a input device adapted to receive input pertaining to route, said input including a route starting point, a route ending point, and a driver indentification.

19. The route information module of claim 18 further comprising a mapping module, said mapping module adapted to provide route information based on said route starting point and said route ending point.

20. The route information module of claim 19 wherein said input further includes entering the route in segments, and further includes altitude gain or loss in one or more of said segments.
